(19) United States
(12) Patent Application Publication
(10) Pub. No.: US 2012/0227898 A1
(43) Pub. Date: Sep. 13, 2012

(54) CONTINUOUS DECORATION TRANSFERRING AND PUNCHING APPARATUS AND PROCESS THEREOF

(75) Inventors: Chih-Chiang Ma, Taoyuan County (TW); Chih-Che Yeh, New Taipei City (TW)

(73) Assignee: ETANSI INC., Taoyuan County (TW)

(21) Appl. No.: 13/413,634

(22) Filed: Mar. 6, 2012

Related U.S. Application Data
(60) Provisional application No. 61/451,607, filed on Mar. 11, 2011.

(51) Int. Cl. B32B 38/04

(52) U.S. Cl. 156/219; 156/516; 156/499; 156/380.9; 156/390; 156/235

(57) ABSTRACT

A continuous decoration transferring and punching apparatus and process thereof which is capable to continuously form a plurality of decorated products is provided. The continuous decoration transferring and punching apparatus includes a first roll feeder for providing a substrate, a second roll feeder for providing a plurality of decoration films, a transferring unit for continuously transferring the decoration films to the substrate and a punching unit for continuously punching the substrate after the decoration films are transferred to the substrate for forming a plurality of decorated pieces. By using the roll feeders to synchronously and continuously transfer the decoration films to the substrate, a large amount of decoration transferred substrates can be obtained at the same time. Moreover, a plurality of decorated pieces can be accomplished through the utilizing of a following punching operation after the transferring process.

### CROSS-REFERENCE TO RELATED APPLICATION

This application claims the priority benefit of U.S. Provisional Application Ser. No. 61/451,607, filed Mar. 11, 2011. The entirety of the above-mentioned patent application is hereby incorporated by reference herein and made a part of this specification.

### BACKGROUND OF THE INVENTION

1. Field of the Invention

The present invention relates to an apparatus and process for decoration transferring and punching. More particularly, the present invention relates to an apparatus and process for continuous decoration transferring and punching.

2. Description of Related Art

Decoration transferring is commonly used in likelihood industry such as forming a decorated sheet to label products or decorating the surface of a plastic housing or a metal housing after the surface treating process. Conventionally, the process for decorating a metal housing is performed after the metal housing is stamped to have a predetermined shape. And before stamping process of the metal housing, the metal substrates to be stamped are usually punched into pieces of metal substrates from a roll of metal substrate. Then, the stamped metal housings must be carefully stored before decoration transferring process so as to avoid from the deformation such as shape being destroyed or product being damaged or the like. However, since the stamped metal housings are usually in a various shape, it is necessary to provide a large space during storing and transporting process. Furthermore, surface treating process is also necessary to the stamped metal housings before the decoration transferring process. Thus, once the surface treating process before the decoration transferring process is invalid, the surface of the metal housing must be treated again. In such procedures of conventional process for decorating a metal housing, the decoration transferring of products can merely be manufactured piece to piece and it is a time consuming and tedious process. Consequently, it will accompany the increasing of cost.

### SUMMARY OF THE INVENTION

Accordingly, the present invention is directed to a continuous decoration transferring and punching apparatus which is capable to continuously form a plurality of decorated products.

The present invention provides a continuous decoration transferring and punching apparatus including a first roll feeder for providing a substrate, a second roll feeder for providing a plurality of decoration films, a transferring unit for continuously transferring the decoration films to the substrate, and a punching unit for continuously punching the substrate after the decoration films are transferred to the substrate for forming a plurality of decorated pieces.

In one embodiment of the present invention, the continuous decoration transferring and punching apparatus further includes two pre-heaters. One of the pre-heaters is disposed between the second roll feeder and the transferring unit for pre-heating the decoration films. Another one of the pre-heaters is disposed between the first roll feeder and the transferring unit for pre-heating the substrate.

In one embodiment of the present invention, the continuous decoration transferring and punching apparatus further includes a leveling unit disposed between the first roll feeder and the transferring unit for leveling the substrate.

In one embodiment of the present invention, the continuous decoration transferring and punching apparatus further includes a vacuum chamber for accommodating the transferring unit.

In one embodiment of the present invention, the continuous decoration transferring and punching apparatus further includes a laser engraver disposed between the first roll feeder and the transferring unit for laser engraving the substrate.

In one embodiment of the present invention, the continuous decoration transferring and punching apparatus further includes a paint sprayer disposed between the first roll feeder and the transferring unit for spraying paint to the substrate.

In one embodiment of the present invention, the continuous decoration transferring and punching apparatus further includes a stamper for stamping the decorated pieces.

In one embodiment of the present invention, the substrate is a metal substrate.

In one embodiment of the present invention, the continuous decoration transferring and punching apparatus further includes a collector for collecting each of the decorated pieces to a container.

The present invention further provides a continuous decoration transferring and punching process including the following steps. First, a roll of substrate is provided. Then, a roll of decoration films is provided. And then, the decoration films are continuously transferred to the substrate. Finally, the substrate is continuously punched after the decoration films are transferred to the substrate for forming a plurality of decorated pieces.

In one embodiment of the present invention, the continuous decoration transferring and punching process further includes pre-heating the decoration films after providing the roll of decoration films and before transferring the decoration films to the substrate.

In one embodiment of the present invention, the continuous decoration transferring and punching process further includes leveling the substrate after providing the roll of substrate and before transferring the decoration films to the substrate.

In one embodiment of the present invention, transferring the decoration films to the substrate is performed in vacuum.

In one embodiment of the present invention, the continuous decoration transferring and punching process further includes laser engraving the substrate after providing the roll of substrate and before transferring the decoration films to the substrate.

In one embodiment of the present invention, the continuous decoration transferring and punching process further includes spraying paint to the substrate after providing the roll of substrate and before transferring the decoration films to the substrate.

In one embodiment of the present invention, the continuous decoration transferring and punching process further includes stamping the decorated pieces.

In one embodiment of the present invention, the continuous decoration transferring and punching process further includes collecting each of the decorated pieces to a container.

In light of the foregoing descriptions, the present invention provides a continuous decoration transferring and punching apparatus and process thereof which is capable to continuously form a plurality of decorated products. In present invention, by using the roll feeders to synchronously and continuously transfer the decoration films to the substrate, a large amount of decoration transferred substrates can be obtained at the same time. Moreover, a plurality of decorated pieces can be accomplished through the utilizing of a following punching operation after the transferring process. Thus, the provided continuous decoration transferring and punching apparatus and process thereof not only can reduce the manufacturing time and the cost can also be decreased.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a continuous decoration transferring and punching apparatus according to an embodiment of the present invention.

FIG. 2 illustrates a process flow chart of the continuous decoration transferring and punching apparatus in FIG. 1.

### DESCRIPTION OF EMBODIMENTS

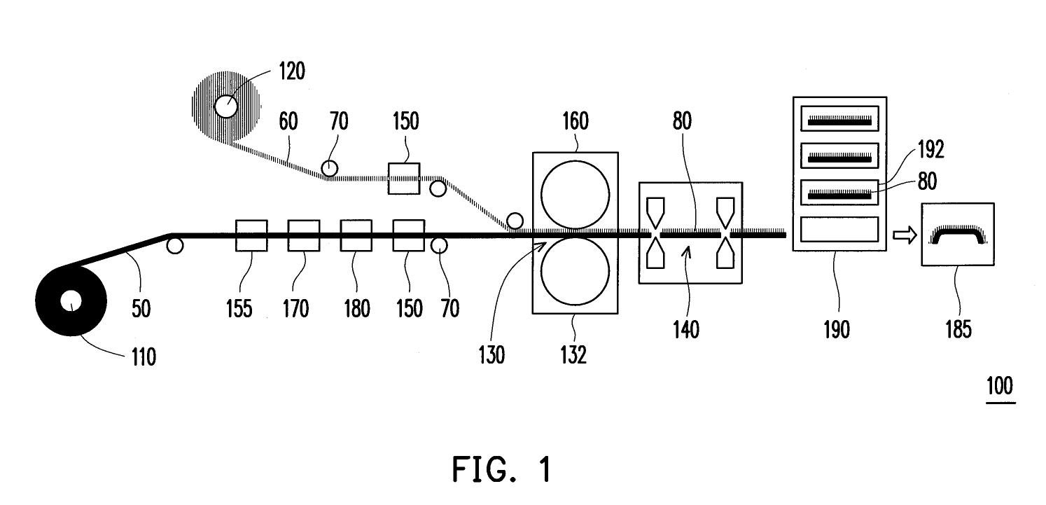

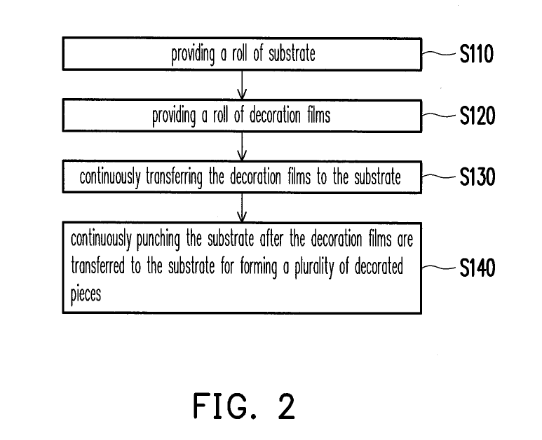

FIG. 1 schematically illustrates a continuous decoration transferring and punching apparatus according to an embodiment of the present invention. FIG. 2 illustrates a process flow chart of the continuous decoration transferring and punching apparatus in FIG. 1. Please refer to FIG. 1 and FIG. 2. In the embodiment, the continuous decoration transferring and punching apparatus 100 includes a first roll feeder 110, a second roll feeder 120, a transferring unit 130 and a punching unit 140. A roll of substrate 50 is provided as shown in step S110 of FIG. 2. The roll of substrate 50 to be decorated is rolled on the first roller 110. The substrate 50 can be a metal substrate, a polymer substrate or ceramic substrate. For example, the substrate 50 is the housing for electronic device, such as notebook, tablet computer, mobile phone or the like. Then, a roll of decoration films 60 is provided as shown in step S120 of FIG. 2. The roll of decoration films 60 is rolled on the second roll feeder 120. Similarly, the decoration film 60 can be a metal film, a polymer film, a ceramic film or a thermal transferring film. The decoration film 60 has a predetermined decorating design on it.

The first roll feeder 110 and the second roll feeder 120 are disposed on a frame (not shown). In the embodiment, the continuous decoration transferring and punching apparatus 100 further includes a motor driving system (not shown) to drive the first roll feeder 110 and the second roll feeder 120 to rotate to continuously feed the substrate 50 and the decoration film 60, respectively.

The transferring unit 130 is for example, formed by two rollers 132 which are adapted to roll oppositely to transfer the decoration films 60 to the substrate 50. While the first roll feeder 110 and the second roll feeder 120 rotate, the substrate 50 and the decoration film 60 are synchronously and continuously provided to the transferring unit 130. And then, the transferring unit 130 continuously transfers the decoration films 60 to the substrate 50 as shown in step S130 of FIG. 2. In the embodiment, the continuous decoration transferring and punching apparatus 100 may further include a vacuum chamber 160 to accommodate the transferring unit 130 to provide a vacuum environment for decoration transferring process. The operating temperature for decoration transferring process, such as the chamber temperature may be between 60° C. to 200° C.

As shown in FIG. 1, the continuous decoration transferring and punching apparatus 100 of the embodiment may further include two pre-heaters 150. One of the pre-heaters 150 is disposed between the second roll feeder 120 and the transferring unit 130 for heating the decoration films 60 before they are attached to the substrate 50. Another one of the pre-heaters 150 is disposed between the first roll feeder 110 and the transferring unit 130 for pre-heating the substrate 50 before they are attached to the decoration films 60. Such pre-heating process can enhance the attaching effect between the decoration films 60 and the substrate 50. Moreover, to further improve the attaching effect, the continuous decoration transferring and punching apparatus 100 may further include a leveling unit 155 in the embodiment. The leveling unit 155 is disposed between the first roll feeder 120 and the transferring unit 130. Before the decoration films 60 transfer to the substrate 50 by the transferring unit 130, the substrate 50 is well flattened by the leveling unit 155 so as to be well attached by the decoration films 60. In this embodiment, in order to stably and properly control the feeding of the decoration films 60 and the substrate 50, the continuous decoration transferring and punching apparatus 100 may further include several guide rollers 70 to keep the substrate 50 and the decoration films 60 in an appropriate tension.

In the embodiment, the continuous decoration transferring and punching apparatus 100 may further include a laser engraver 170 if the substrate 50 needs to be laser engraved before the decoration transferring process. The laser engraver 170 is disposed between the leveling unit 155 and the transferring unit 130. Similarly, if the substrate 50 is required to be painted a specific color or a background color before the decoration transferring process, the continuous decoration transferring and punching apparatus 100 may further include a paint sprayer or a gravure printer or screen printer or a glue stamper 180. The paint sprayer 180 is disposed between the laser engraver 170 and the transferring unit 130.

Finally, the substrate 50 is punched after the decoration films 60 are transferred to the substrate 50 for forming a plurality of decorated pieces 80 as shown in step S140 of FIG. 2. The punching unit 140 is disposed next to the transferring unit 130 as shown in FIG. 1. Since, the decorated pieces 80 are already in a compact size, unlike the conventional stamped decorated piece which are decorated and shaped into a predetermined shape, it is rather convenient to store the resulting decorated pieces 80. Consequently the storing of the decorated pieces 80 occupies few spaces and it results the manufacturing cost decrease. In addition, unlike the requirement of surface treating to decorated pieces of conventional decorating process, since each of the decorated pieces 80 of the embodiment are already protected by the decoration film 60, the additional surface treating process for protection is unnecessary. Moreover, under such protection by the decoration film 60, the decorated pieces 80 will not lose quality over time, so that the following process such as stamping process can be performed any time. And thus, the continuously transferring process can reduce the tact time and manufacturing cost.

In the embodiment, alignment marks may also done onto the decoration film 60 before punching process, and the punching unit 140 may include at least one alignment sensor to detect the alignment marks. The alignment marks can facilitate the decorated pieces 80 to be punched accurately. A collector 190 can be disposed next to the punching unit 140 in the embodiment. The collector 190 collects each of the decorated pieces 80 to a container 192 to have the decorated pieces 80 stored and transported safely. In the embodiment, the continuous decoration transferring apparatus 100 may further include a stamper 185 to stamp the decorated pieces 80 to have a specific shape. Furthermore, since the decoration film 60 has already included a protecting layer such as a polymer film made of polyethylene terephthalate (PET) or other polymer, each of the decorated pieces 80 is provided with a proper protection during the stamping process. The protecting layer on the decorated pieces 80 is usually peeled after all the processes are finished.

In light of the foregoing descriptions, the present invention provides a continuous decoration transferring and punching apparatus and process thereof which is capable to continuously form a plurality of decorated products. In present invention, by using the roll feeders to synchronously and continuously transfer the decoration films to the substrate, a large amount of decoration transferred substrates can be obtained at the same time. Moreover, a plurality of decorated pieces can be accomplished through the utilizing of a following punching operation after the transferring process. Thus, the provided continuous decoration transferring and punching apparatus and process thereof not only can reduce the manufacturing time and the cost can also be decreased.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A continuous decoration transferring and punching apparatus, comprising:
a first roll feeder for providing a substrate;
a second roll feeder for providing a plurality of decoration films;
a transferring unit for continuously transferring the decoration films to the substrate; and
a punching unit for continuously punching the substrate after the decoration films are transferred to the substrate for forming a plurality of decorated pieces.

2. The continuous decoration transferring and punching apparatus as claimed in claim 1, further comprising two pre-heaters, wherein one of the pre-heaters is disposed between the second roll feeder and the transferring unit for pre-heating the decoration films, and another one of the pre-heaters is disposed between the first roll feeder and the transferring unit for pre-heating the substrate.

3. The continuous decoration transferring and punching apparatus as claimed in claim 1, further comprising a leveling unit disposed between the first roll feeder and the transferring unit for leveling the substrate.

4. The continuous decoration transferring and punching apparatus as claimed in claim 1, further comprising a vacuum chamber for accommodating the transferring unit.

5. The continuous decoration transferring and punching apparatus as claimed in claim 1, further comprising a laser engraver disposed between the first roll feeder and the transferring unit for laser engraving the substrate.

6. The continuous decoration transferring and punching apparatus as claimed in claim 1, further comprising a paint sprayer disposed between the first roll feeder and the transferring unit for spraying paint to the substrate.

7. The continuous decoration transferring and punching apparatus as claimed in claim 1, further comprising a stamper for stamping the decorated pieces.

8. The continuous decoration transferring and punching apparatus as claimed in claim 1, wherein the substrate is a metal substrate.

9. The continuous decoration transferring and punching apparatus as claimed in claim 1, further comprising a collector for collecting each of the decorated pieces to a container.

10. A continuous decoration transferring and punching process, comprising:
providing a roll of substrate;
providing a roll of decoration films;
continuously transferring the decoration films to the substrate; and
continuously punching the substrate after the decoration films are transferred to the substrate for forming a plurality of decorated pieces.

11. The continuous decoration transferring and punching process as claimed in claim 10, further comprising pre-heating the decoration films after providing the roll of decoration films and before transferring the decoration films to the substrate.

12. The continuous decoration transferring and punching process as claimed in claim 10, further comprising leveling the substrate after providing the roll of substrate and before transferring the decoration films to the substrate.

13. The continuous decoration transferring and punching process as claimed in claim 10, wherein transferring the decoration films to the substrate is performed in vacuum.

14. The continuous decoration transferring and punching process as claimed in claim 10, further comprising laser engraving the substrate after providing the roll of substrate and before transferring the decoration films to the substrate.

15. The continuous decoration transferring and punching process as claimed in claim 10, further comprising spraying paint to the substrate after providing the roll of substrate and before transferring the decoration films to the substrate.

16. The continuous decoration transferring and punching process as claimed in claim 10, further comprising stamping the decorated pieces.

17. The continuous decoration transferring and punching process as claimed in claim 10, further comprising collecting each of the decorated pieces to a container.
